(19) United States
(12) Patent Application Publication
(10) Pub. No.: US 2015/0186536 A1
(43) Pub. Date: Jul. 2, 2015

(54) METHODS AND APPARATUS TO MONITOR MEDIA PRESENTATIONS

(71) Applicant: The Nielsen Company (US), LLC, Schaumburg, IL (US)

(72) Inventors: Alan N. Bosworth, Odessa, FL (US); Daniel Krotov, Trinity, FL (US); Steven J. Splaine, Tampa, FL (US); Kevin K. Gaynor, Sunnyvale, CA (US)

(21) Appl. No.: 14/453,840

(22) Filed: Aug. 7, 2014

Related U.S. Application Data
(60) Provisional application No. 61/922,340, filed on Dec. 31, 2013.

(51) Int. Cl. G06F 17/30

(52) U.S. Cl. CPC G06F 17/30867

(57) ABSTRACT

Methods and apparatus to monitor media presentations are disclosed. An example method includes storing a consent indicator at a central facility in connection with a user of a media device; and, when monitoring data representative of an exposure to media of the user is received, determining a value of the consent indicator; when the value indicates that the user is an opted-in user, storing a first type of exposure indication in association with the first media, the first type of exposure indication to include personally identifying information associated with the user stored in connection with the first media; and when the value indicates that the user is an opted-out user, storing a second type of exposure indication in association with the first media, the second type of exposure indication to omit the personal identifying information associated with the user from being stored in connection with the first media.

### RELATED APPLICATION

This patent claims the benefit of U.S. Provisional Patent Application No. 61/922,340, filed on Dec. 31, 2013, which is hereby incorporated herein in its entirety.

### FIELD OF THE DISCLOSURE

This disclosure relates generally to audience measurement, and, more particularly, to methods and apparatus to monitor media presentations.

### BACKGROUND

Media monitoring companies desire information related to user interactions with, for example, media devices. In particular, the media monitoring companies obtain monitoring information related to media presented at the media devices such that the media monitoring entities gain knowledge of, for example, exposure to advertisements, exposure to programming, user purchasing activity correlated to exposure to media, demographic information for audiences exposed to media, etc.

### BRIEF DESCRIPTION OF THE DRAWINGS

FIG. 1 is a block diagram of an example system constructed in accordance with the teachings of this disclosure to monitor media presentations.

FIG. 2 is a block diagram of an example implementation of the example monitoring data analyzer of FIG. 1.

FIG. 3 is a block diagram of an example implementation of the example reporter of FIG. 1.

FIG. 4 is a flowchart representative of example machine-readable instructions that may be executed to implement the example media device of FIG. 1.

FIG. 5 is a flowchart representative of example machine-readable instructions that may be executed to implement the example monitoring data analyzer of FIGS. 1 and/or 2.

FIG. 6 is a flowchart representative of example machine-readable instructions that may be executed to implement the example reporter of FIGS. 1 and/or 3.

FIG. 7 is a flowchart representative of example machine-readable instructions that may be executed to implement the example central facility of FIGS. 1 and/or 2.

FIG. 8 is a block diagram of an example processor platform capable of executing the example machine-readable instructions of FIG. 4 to implement the example media device of FIG. 1, capable of executing the example machine-readable instructions of FIG. 5 to implement the example monitoring data analyzer of FIGS. 1 and/or 2, capable of executing the example machine-readable instructions of FIG. 6 to implement the example reporter of FIGS. 1 and/or 3, and/or capable of executing the example machine-readable instructions of FIG. 7 to implement the example central facility 100 of FIG. 1.

### DETAILED DESCRIPTION

As used herein, the term “media” includes any type of content and/or advertisement delivered via any type of distribution medium. Thus, media includes television programming or advertisements, radio programming or advertisements, movies, web sites, streaming media, etc. Media devices may include, for example, Internet-enabled televisions, personal computers, Internet-enabled mobile handsets (e.g., a smart phone), video game consoles (e.g., Xbox®, PlayStation® 3), tablet computers (e.g., an iPad®), digital media players (e.g., a Roku® media player, a Slingbox®, etc.), etc.

Media monitoring companies desire information related to user interactions with media devices. In particular, media monitoring companies wish to obtain monitoring information related to media presented at the media devices such that the media monitoring entities gain knowledge of, for example, exposure to advertisements, exposure to programming, user purchasing activity responsive to exposure to media, demographic information for audiences exposed to media, etc. Monitoring information includes, for example, media identifying information (e.g., media-identifying metadata, codes, signatures, watermarks, and/or other information that may be used to identify presented media), application usage information (e.g., an identifier of an application, a time and/or duration of use of the application, a rating of the application, etc.), and/or user-identifying information (e.g., demographic information, a panelist identifier, a username, etc.). Media identifying information may be aggregated to determine and/or estimate, for example, exposure of one or more populations and/or demographics to particular media and/or type(s) of media, ownership and/or usage statistics of media devices, relative rankings of usage and/or ownership of media devices, types of uses of media devices (e.g., whether a device is used for browsing the Internet, streaming media from the Internet, etc.), and/or other types of media device information.

Media devices such as tablet computers (e.g., an Apple iPad®, an Asus Transformer™, etc.) present media using applications (sometimes referred to as “apps”) that access, retrieve, request, and/or present media (e.g., Internet media). Many different “Apps” exist and can be downloaded by users through app stores such as, for example, Apple iTunes®, Google Play®, etc. Examples of such applications include, but are not limited to, Hulu®, Netflix®, HBO Go®, etc. Operating systems used on media devices are often closed platforms. That is, the operating systems provide a limited set of functions that applications executed by the media device can access via, for example, an Application Programming Interface (API). In some operating systems, only a single application is executed at one time. When the media device executes the app, the app is typically run in a “sand-box.” That is, the app is not allowed to communicate with other apps executed by the media device. In some examples, apps have access to a limited set of functionality for sharing data with other apps. For example, applications executed on the iOS operating system have access to a “pasteboard” that allows applications to share information. Thus, communicating with applications to identify and/or monitor media presentation events on devices using a “sandbox” approach is difficult.

In addition to the difficulties of monitoring media devices capable of executing apps in the environments described above, maintaining privacy of users of such media devices is challenging. In some instances, users do not want media exposure information (e.g., media identifiers) stored or associated with their personal information and/or demographic information by, for example, the monitoring entities. That is, some people do not want monitoring entities to tie their identities to particular media exposure habits and/or activity. Therefore, monitoring entities may request consent from, for example, the users of media devices having monitoring functionality installed thereon. In principle, consent to monitoring could be gathered by every application instrumented with monitoring functionality by causing each such instrumented application to ask the user for permission to enable monitoring. However, on devices that include many apps, the user would be asked for their permission many times. Repeatedly asking the user for their permission to enable monitoring may discourage the user from consenting to or even considering the monitoring. Moreover, from a computing perspective, repeatedly requesting and/or repeatedly receiving consent information (e.g., permission or an opt-out selection) strains the resources (e.g., processing resources and/or memory) of the media device and the resources of computing devices (e.g., servers) of the monitoring entities receiving the information. For example, the monitoring entity may be required to process (e.g., extract, compare, and/or other analyze) consent information each time a piece of monitoring information is received from a media device that sends monitoring information to the monitoring entity hundreds or thousands of times per day. Furthermore, privacy is a concern and/or desire for people utilizing any type of media device including, for example, a television located in a living room and/or other types of computing devices such as desktop computers and/or laptops.

Examples methods, apparatus, and/or articles of manufacture disclosed herein enable monitoring entities to implement a convenient opt-out option for users of media devices. In examples disclosed herein, consent information is obtained from users of media devices in connection with, for example, monitoring functionality associated with (e.g., installed on and/or deployed in connection with) the media devices. The consent information is obtained by, for example, prompting the user for the consent information at a time of a registration and/or activation and sending the same to a central facility associated with the monitoring entity. In examples disclosed herein, a consent indicator having a first value indicative of permission to monitor or a second value indicative of the user opting out of the monitoring is stored for the corresponding person at the central facility. Examples disclosed herein use the consent indicator for each person to enforce the privacy preference of each person at the central facility. That is, examples disclosed herein track, at the central facility of the monitoring entity, which users have opted out of the monitoring functionality implemented on a corresponding media device and which persons have provided consent to the monitoring functionality. Using the tracked consent information, examples disclosed herein enforce privacy restrictions at the central facility for the persons that have opted out of the monitoring. Thus, examples disclosed herein absolve the media devices on which the monitoring is being performed from having to enforce privacy protections (at least in connection with the monitoring functions being implemented by the monitoring entity associated with the central facility).

As monitoring information (e.g., packages of monitoring data) is received at the central facility, examples disclosed herein enforce the privacy instructions of the corresponding person. The received monitoring data includes, for example, media identifying information (e.g., a code, a signature, a watermark, etc.) indicative of media to which a user was exposed via a media device an user identifying information (e.g., a name, an assigned identifier, etc.) indicative of an identity of the person exposed to the identified media. When the central facility receives the monitoring data from the media devices, examples disclosed herein determine whether the received monitoring data is associated with someone that has granted monitoring permission or someone for which an opt-out instruction has been received. In some examples, the determination of whether or not the user has opted out is made by comparing the received user identifying information to the consent indicators stored at the central facility.

When one of the consent indicators stored at the central facility indicates that the received monitoring data is associated with a user that has provided consent, examples disclosed herein store a first type of exposure indication at the central facility. When the first type of exposure indication is stored, the central facility of examples disclosed herein (1) credits the identified media with an exposure and (2) stores personally identifying information associated with the user (e.g., demographic information and/or bibliographic information) at the central facility in connection with the identified media. In some examples, the personally identifying information associated with the user is known to the central facility (e.g., prior to receiving in the monitoring data per a previous survey or inquiry or by the information accompanying the received monitoring data). In contrast, when one of the consent indicators stored at the central facility indicates that the received monitoring data is associated with a user that has opted-out of monitoring, examples disclosed herein store a second, different type of exposure indication at the central facility. When the second type of exposure indication is stored, the central facility of examples disclosed herein (1) credits the identified media with an exposure and (2) prevents the personally identifying information associated with the user from being stored at the central facility in connection with the identified media.

Thus, examples disclosed herein generate a first collection or plurality of exposure indications associated with opted-in users for particular media and a second collection or plurality of exposure indications associated with opted-out users for the particular media. Further, examples disclosed herein use the personally identifying information stored in connection with the first (opted-in) plurality of exposure indications to generate, for example, a demographic profile of the first plurality of exposure indications for the particular media. Examples disclosed herein project (e.g., extrapolate) the demographic profile of the first plurality of exposure indications onto the second (opted-out) plurality of exposure indications to, for example, estimate a second demographic profile for the opted-out users. Accordingly, examples disclosed herein enable the monitoring entities to generate, for example, demographic information associated with media exposures even when the corresponding users have opted-out of having their actual demographic information stored in connection with media exposure indications and without violating the privacy of those individuals. Thus, examples disclosed herein enable generation of demographic exposure data (e.g., statistics) while maintaining the privacy of opted-out users. Put another way, examples disclosed herein provide monitoring entities with knowledge of a (likely or approximate) demographic makeup of opted-out users exposed to particular media despite not storing the actual demographic information of those individuals in association with certain exposures to the particular media. Moreover, examples disclosed herein enable enforcement of the privacy preferences of the users while allowing the media devices to send monitoring information to the central facility without the overhead of enforcing privacy instructions and/or preferences. Put another way, examples disclosed herein absolve the media device from having to repeatedly obtain, send, and/or otherwise process consent of the user each time monitoring information is captured and/or transmitted, because the privacy restrictions are enforced at the central location.

While especially useful for monitoring functionality implemented on a media device implemented a plurality of apps, such as a tablet, smart phone, etc., examples disclosed herein may be implemented in connection with any type of monitoring functionality that conveys monitoring data to a central facility. Thus, while described below in connection with a portable computing device, examples disclosed herein may be implemented in connection with, for example, a base monitoring unit deployed in a living room that conveys monitoring data packages including media identifying information (e.g., data indicative of a media presented in the living room) and user identifying information (e.g., data indicative of an identity of a person located in the living room at a time of the media presentation obtained via, for example, user input, facial recognition, voice recognition, presence of a portable device associated with the person, etc.). That is, examples disclosed herein may enable monitoring entities to monitor media while maintaining user privacy in any suitable monitoring environment and/or in connection with any suitable monitoring device.

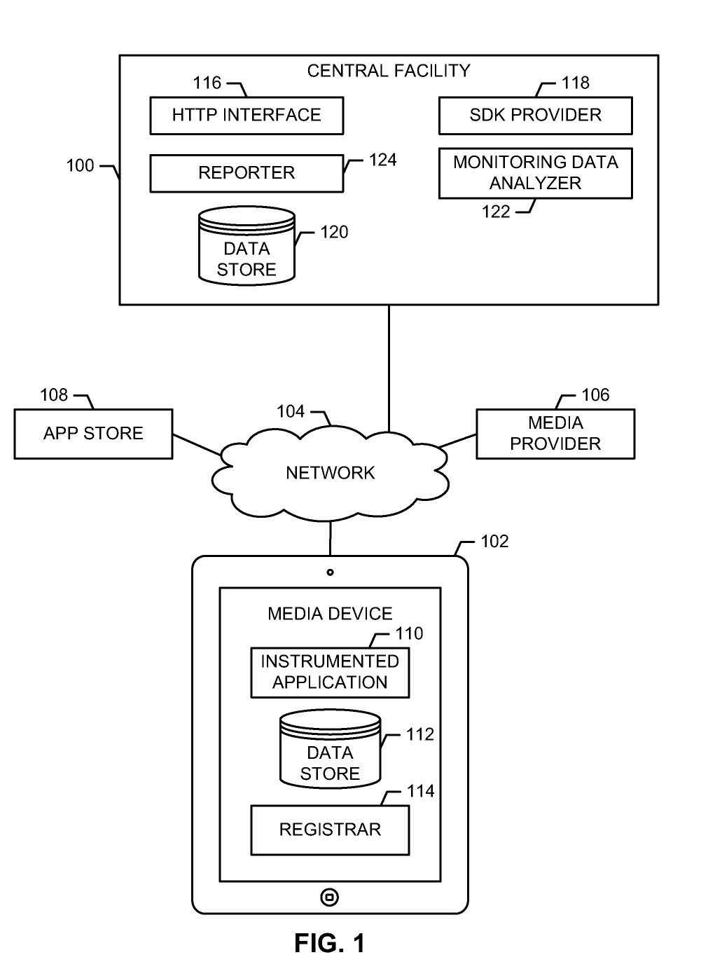

FIG. 1 is a block diagram including a central facility 100 constructed in accordance with teachings of this disclosure to monitor media. The example central facility 100 of FIG. 1 is in communication with a media device 102 via, for example, a network 104 and/or direct communication. The example network 104 of FIG. 1 is a wide area network (WAN) such as the Internet. However, in some examples, local networks may additionally or alternatively be used. For example, multiple networks (e.g., a cellular network, an Ethernet network, etc.) may be utilized to implement the example network 104 of FIG. 1. The example media device 102 of FIG. 1 facilitates one or more of the media presentations corresponding to, for example, media retrieved and/or otherwise obtained from a media provider 106. The example media provider 106 of FIG. 1 may be implemented by any provider(s) of media such as a media broadcaster, multicaster, or unicaster (e.g., a cable television service, a fiber-optic television service, an IPTV provider, etc.), an on-demand digital media provider (e.g., an Internet streaming video and/or audio services such as Netflix®, YouTube®, Hulu®, Pandora®, Last.fm®, etc.), a web page, and/or any other provider of media.

In the example of FIG. 1, the media device 102 of FIG. 1 is a tablet, such as an Apple iPad™. As such, the example media device 102 is sometimes in communication with an app store 108 (e.g., the Apple iTunes® app store). In the illustrated example of FIG. 1, the app store 108 provides applications (e.g., apps designed for execution on an iPad®) to media devices, such as the example media device 102 of FIG. 1. Any other app store and/or repository of applications/apps (e.g., Google Play, the Windows Phone app store, the Ubuntu Software Center, etc.) may additionally or alternatively be used by the example media device 102 of FIG. 1. While in the illustrated example of FIG. 1 the media device is a tablet, any other type(s) and/or number(s) of media device(s) may additionally or alternatively be used. For example, Internet-enabled mobile handsets (e.g., a smart phone, an iPod®, etc.), video game consoles (e.g., Xbox®, PlayStation 3, etc.), tablet computers (e.g., an iPad®, a Motorola™ Xoom™, etc.), digital media players (e.g., a Roku® media player, a Slingbox®, a Tivo®, etc.), smart televisions, etc. may additionally or alternatively be used.

The example media device 102 of FIG. 1 executes an instrumented application 110 that gathers information related to media presentations and/or other usage activity associated with the media device 102. In particular, the example instrumented application 110 of FIG. 1 executes monitoring functionality to detect and/or identify the media being presented on the media device 102 and/or media being presented in an environment in which the media device 102 is located. The example instrumented application 110 of FIG. 1 is software downloadable via, for example, the Internet. In the illustrated example of FIG. 1, the instrumented application 110 is provided by the media provider 106. However, the instrumented application 110 may be provided by any other entity (e.g., a monitoring entity, such as The Nielsen Company). In some examples, in addition to monitoring the media device 102 and/or an environment in which the media device 102 is located, the instrumented application 110 of FIG. 1 presents media retrieved from, for example, the media provider 106 (e.g., by interacting with a QuickTime® application programming interface (API) to display media and/or an Adobe® Flash® media presentation framework). In some examples, the instrumented application 110 has a primary function different than media monitoring such as, for example, presenting media from a particular provider (e.g., when the instrumented application 110 is dedicated to a particular media provider (e.g., a television broadcaster such as ESPN, ABC, NBC, etc.).

In some examples, the instrumented application 110 is installed on the media device 102 via the user downloading the instrumented application 110 from the example app store 108 (e.g. Apple iTunes, Google play, etc.). In the example of FIG. 1, an SDK kit may be provided (e.g., by an entity associated with the central facility 100) to application developers associated with the media provider 106. In such instances, the media provider 106 employs the SDK to generate the instrumented application 110 and posts the instrumented application 110 to the app store 108. Members of the general public, some of which are panelists of a monitoring entity associated with the central facility 100, may download the instrumented application 110 to respective media device(s). People become panelists via, for example, a user interface presented on the media device 102 (e.g., a website displayed on a touch screen). People become panelists in additional or alternative manners such as, for example, via a telephone interview, by completing an online survey, etc. Additionally or alternatively, people may be contacted and/or enlisted using any desired methodology (e.g., random selection, statistical selection, phone solicitations, Internet advertisements, surveys, advertisements in shopping malls, product packaging, etc.).

In the example of FIG. 1, the example instrumented application 110 of FIG. 1 is instrumented with monitoring functionality that collects monitoring data (e.g., media identifying information, user identifying information, device identifying information, etc.) and transmits the same to the example central facility 100 (e.g., via the network 104). In some examples, the instrumented application 110 of FIG. 1 extracts, for example, codes and/or watermarks embedded in media presented by the media device 102. Audio watermarking is a technique used to identify media such as television broadcasts, radio broadcasts, advertisements (television and/or radio), downloaded media, streaming media, prepackaged media, etc. Existing audio watermarking techniques identify media by embedding one or more audio codes (e.g., one or more watermarks), such as media identifying information and/or an identifier that may be mapped to media identifying information, into an audio and/or video component. In some examples, the audio or video component is selected to have a signal characteristic sufficient to hide the watermark. As used herein, the terms “code” or “watermark” are used interchangeably and are defined to mean any identification information (e.g., an identifier) that may be inserted or embedded in the audio or video of media (e.g., a program or advertisement) for the purpose of identifying the media or for another purpose such as tuning (e.g., a packet identifying header). To identify watermarked media, the watermark(s) are extracted and used to access a table of reference watermarks that are mapped to media identifying information.

Additionally or alternatively, the example instrumented application 110 of FIG. 1 facilitates generation of fingerprints and/or signatures representative of media presented on the media device 102. Unlike media monitoring techniques based on codes and/or watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A good signature is one that is repeatable when processing the same media presentation, but that is unique relative to other (e.g., different) presentations of other (e.g., different) media. Accordingly, the term “fingerprint” and “signature” are used interchangeably herein and are defined herein to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature. Example systems for identifying media based on codes and/or signatures are long known and were first disclosed in Thomas, U.S. Pat. No. 5,481,294, which is hereby incorporated by reference in its entirety.

In some examples, the code/watermark is transmitted with and/or in association with the media as media-identifying metadata. The media-identifying metadata may be formatted in a text or binary format such as, for example, an ID3 tag. In some examples, the media-identifying metadata includes the code/watermark, etc. However, in some other examples, the media-identifying metadata is derived from and/or representative of the code/watermark, and/or a signature, etc. Example methods and apparatus to transcode watermarks into ID3 tags are disclosed in U.S. patent application Ser. No. 13/341,646, U.S. patent application Ser. No. 13/341,661, U.S. patent application Ser. No. 13/443,596, U.S. patent application Ser. No. 13/455,961, U.S. patent application Ser. No. 13/341,646, and U.S. patent application Ser. No. 13/472,170 which are hereby incorporated by reference in their entireties.

In the illustrated example of FIG. 1, the monitoring functionality of the instrumented application 110 stores data associated with and/or representative of the collected information in, for example, a data store 112 of the media device 102 and/or transmits the collected monitoring information to the example central facility 100. In the example of FIG. 1, the data store 112 of the media device 102 is any device capable of storing data such as, for example, flash memory, magnetic media, optical media, etc. and is formatted in any suitable data format such as, for example, binary data, comma delimited data, tab delimited data, structured query language (SQL) structures, etc. In some examples, the media device 102 includes additional or alternative monitoring functionality (e.g., native monitoring functionality and/or monitoring software other than the software of the instrumented application). In some examples, the monitoring functionality of the instrumented application 110 and/or other monitoring functions operating on the media device 102 are referred to as “on-device meters.”

The example media device 102 of FIG. 1 includes a registrar 114 to obtain information including, for example, consent information and/or personally identifying information associated with one or more persons likely to use the media device 102 (e.g., an owner of the media device 102, a family member related to the owner of the media device 102, a co-worker of the owner of the media device 102, etc.). Personally identifying information associated with a person includes, for example, demographic information, bibliographic information, lifestyle information, panel registration information, etc. The one or more persons likely to use the media device 102 are sometimes referred to herein as user(s) of the media device 102. In some examples, the registrar 114 presents a plurality of questions to obtain, for example, the personally identifying information. Additionally, the example registrar 114 requests permission from the one or more users to monitor activity (e.g. media exposure activity) on the media device 102 (e.g., via the instrumented application 110). In the illustrated example, the registrar 114 requests the consent information by presenting an opt-out option to the user of the media device 102. The example registrar 114 of FIG. 1 obtains individual consent information for different users. That is, a first user of the media device 102 may provide permission for the central monitoring facility 100 to obtain and store personally identifying information associated with the first user in connection with collected media identifying information representative of media to which the first user was exposed. Further, a second user of the media device 102 may select an opt-out option presented by the registrar 114 to instruct the central facility 100 to prevent storage of the personally identifying information associated with the second user from being stored in connection with the media identifying information representative of media to which the second user was exposed. Put another way, by selecting the opt-out option presented by the registrar 114, the second user of the media 102 prohibits the central facility 100 from storing personally identifying information in conjunction with media identifying information collected from the media device 102. In the illustrated example of FIG. 1, the registrar 114 requests the consent and/or opt-out instruction at a similar time as installation and/or activation of the instrumented application 110. In some instances, the consent information is obtained once and persists throughout extended use of the media device 102 (e.g., across many usage sessions and/or across many applications). However, the example registrar 114 of FIG. 1 may periodically and/or aperiodically prompt the user of the media device 102 for permission and/or opt-out instructions at any suitable time(s). In some examples, the user may be offered incentives (e.g., cash, gift cards, goods, services, etc.) in exchange for their permission to enable monitoring. In examples where the user has given consent, it may further be advantageous to periodically and/or a-periodically remind the user that they have given their consent to be monitored.

The example registrar 114 of FIG. 1 sends the obtained consent information (e.g., a permission to monitor, an absence of a selection, or an opt-out instruction) to the central facility 100 in conjunction with identifying information indicative of an identity of the corresponding user (e.g., a user identifier, a panelist identifier, and/or a device identifier). In some examples, the registrar 114 sends demographic information collected from the user(s) to the central facility 100 in conjunction with the user identifying information and/or consent information. In some instances, the example central facility 100 obtains personally identifying information associated with the users (e.g., demographic information, bibliographic information, etc.) from alternative sources and, as such, the registrar 114 does not need to collect the personally identifying information from the users. In some examples, when the received consent information indicates that the corresponding user opted out, the central facility 100 determines whether that user is a panelist. If the example central facility 100 of FIG. 1 determines that the user is a panelist and has opted out of monitoring, the central facility 100 sends a message (e.g., via email, mail, telephone call, etc.) reminding the user of the agreement to be a panelist. In some examples, registration with the central facility 100 as a panelist is accompanied with certain terms that may be contradicted by opting out. In the illustrated example, the central facility 100 informs the user that opting out may result in removal from the panel and expiration any accompanying terms (e.g., compensation). In some examples, the central facility 100 may send one or more reminders to the user and/or provide the user with one or more opportunities to opt back in to the monitoring associated with membership in the panel. As such, the example central facility 100 tracks whether panelist have opted out such that the panel is not tainted by non-compliant members.

When the example instrumented application 110 of FIG. 1 detects media being presented on the media device 102, the instrumented application 110 sends a package of monitoring information to the central facility 100. In the illustrated example of FIG. 1, the monitoring information package includes data indicative of the detected media and data indicative of an identity of the user. In some examples, the monitoring information package additionally includes personally identifying information associated with the user such as demographic information and/or bibliographic information. Notably, the example instrumented application 110 of FIG. 1 sends the monitoring information to the central facility 100 regardless of the consent information previously provided by the user(s) of the media device 102. Instead, the privacy of opted-out users of the media device 102 is enforced at the central facility 100 according to examples disclosed herein. In particular, the example central facility 100 of FIG. 1, which stored opt-out instructions for the user prior to receiving the monitoring information package, prevents the personally identifying information corresponding to the monitoring package from being stored in connection with the monitoring package. Thus, while the central facility 100 stores records of the monitoring packages corresponding to the opted-out users, no association between the media identifying information of the package and the personally identifying information of the package is stored at the example central facility 100 of FIG. 1. In some examples, the personally identifying information of the opted-out user is discarded and/or destroyed.

To exchange information with the media device 102 via the network 104, the example central facility 100 of FIG. 1 includes an interface 116 to receive reported monitoring information from, for example, the media device 102 via the network 104. The example interface 116 of FIG. 1 is a Hyper Text Transfer Protocol (HTTP) interface. However, the example central facility 100 of FIG. 1 may utilize any suitable type(s) of interface(s) and/or protocol(s). In the illustrated example, the HTTP interface 116 receives HTTP requests that include, for example, media monitoring information. In some examples, the HTTP requests are sent with the media monitoring information in a payload portion of the requests. The media monitoring information received via the HTTP requests includes, for example, media-identifying information (e.g., media-identifying metadata, codes, signatures, watermarks, and/or other information that may be used to identify presented media), user identifying information (e.g., an alphanumeric identifier assigned to the current user), personally identifying information (e.g., demographic information, bibliographic information, etc.), application usage information (e.g., an identifier of an application, a time and/or duration of use of the application, a rating of the application, etc.), and/or any other suitable monitoring information. The requests may not be intended to actually retrieve media, but are instead used as a vehicle to convey the media monitoring information. Thus, the HTTP requests may be referred to as “dummy requests”. The example central facility 100 of FIG. 1 is provided with software (e.g., a daemon) to extract the media monitoring information from the payload of the dummy request(s). Additionally or alternatively, any other method(s) to transfer the media monitoring information may be used such as, for example, an HTTP Secure protocol (HTTPS), a file transfer protocol (FTP), a secure file transfer protocol (SFTP), an HTTP and/or HTTPS GET request, an HTTP and/or HTTPS POST request, etc.

The example central facility 100 of FIG. 1 includes an SDK provider 118 to provide instructions to application developers to facilitate creation of, for example, the instrumented application 110 and/or the registrar 114. In some examples, the SDK provider 118 provides the SDK to the application developers such that the developers can integrate monitoring instructions into existing applications. While in the illustrated example of FIG. 1 an SDK is provided, the monitoring components instrumented by the SDK and/or monitoring instructions provided via the SDK may be provided in any other suitable manner. For example, the monitoring instructions may be provided as an application programming interface (API), a plugin, an add-on, etc. Alternatively, the monitoring instructions may be maintained externally and the SDK may facilitate installation of a link to the monitoring instructions into the application.

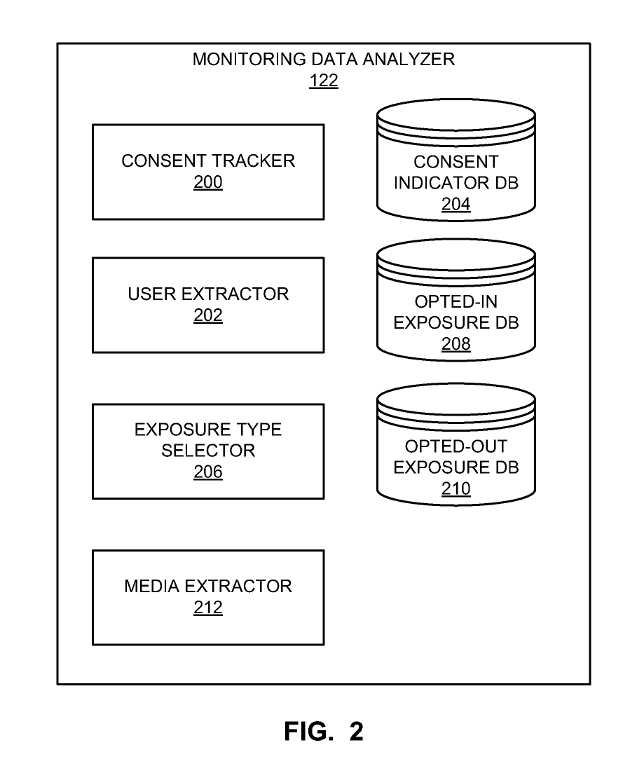

The example central facility 100 of FIG. 1 includes a data store 120 that is implemented by one or more storage device such as, for example, flash memory, magnetic media, optical media, etc. The data stored in the example data store 100 of FIG. 1 may be in any data format such as, for example, binary data, comma delimited data, tab delimited data, structured query language (SQL) structures, etc. While in the illustrated example of FIG. 1 the data store 100 is illustrated as a single database, the data store 120 may be implemented by multiple databases, and/or be stored in multiple memory locations. The example data store 120 of FIG. 1 stores, for example, the monitoring information received from the media device 102. In some examples, the data store 120 stores personally identifying information (e.g., demographic information, bibliographic information, etc.) in connection with, for example, one or more panelists and/or other people indicative of one or more characteristics of the corresponding person. As disclosed below in connection with FIG. 2, whether or not the personally identifying information corresponding to a user identified in received monitoring information depends on the consent information stored at the central facility 100 for the user associated with the received monitoring information.

The example central facility 100 of FIG. 1 includes a monitoring data analyzer 122 to analyze monitoring information received from, for example, the instrumented application 110. Monitoring information includes, for example, media identifying information (e.g., media-identifying metadata, codes, signatures, watermarks, and/or other information that may be used to identify presented media), application usage information (e.g., an identifier of an application, a time and/or duration of use of the application, a rating of the application, etc.), user-identifying information (e.g., a panelist identifier, a username, etc.), etc. As disclosed below in connection with FIG. 2, example analyses performed by the monitoring data analyzer 122 of FIG. 1 include determining whether received monitoring information corresponds to a user that has consented to monitoring or a user that has opted out of monitoring. Based on this determination, the example monitoring data analyzer 122 of FIG. 1 stores the monitoring information in isolation from personally identifying information associated with the user or in conjunction with personally identifying information associated with the user. The example monitoring data analyzer 122 of FIG. 1 is described in greater detail below in connection with FIG. 2.

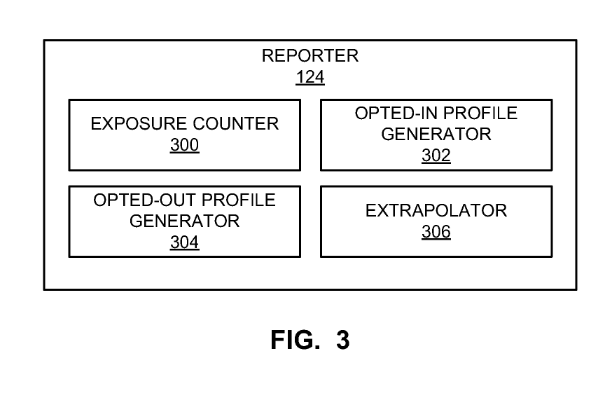

The example central facility 100 of FIG. 1 includes a reporter 124 to generate one or more reports and/or outputs representative of, for example, the monitoring information received from the instrumented application 110 and/or data extrapolated from the monitoring information. As disclosed below in connection with FIG. 3, the example reporter 124 uses information stored in connection with opted-in users to estimate and/or approximate, for example, demographic information of opted-out users for which demographic information is not stored in connection with detected media exposures.

Although for simplicity, the above discussion focuses on a single media device 102, a single instrumented application 110, a single media provider 106, a single app store 108, and a single central facility 100, any number of any of these elements may be present. For example, in a typical implementation, it is expected that multiple media providers will offer multiple different instrumented applications to the public at large. Thus, it is expected that there will be many media devices accessing such applications, and that a significant portion of the users will agree to be panelists. Thus, it is expected that there will be many instances of the above processes conducted across many devices at the overlapping and/or distinct times. Thus, for example, there may be many instantiations of the machine-readable instructions disclosed in the below flowcharts operating at the same or different time. Some of these instances may be implemented as parallel threads operating on a same device.

While an example manner of implementing the media device 102 is illustrated in FIG. 1, one or more of the elements, processes and/or devices illustrated in FIG. 1 may be combined, divided, re-arranged, omitted, eliminated and/or implemented in any other way. Further, the example instrumented application 110, the example registrar 114 and/or, more generally, the example media device 102 of FIG. 1 may be implemented by hardware, software, firmware and/or any combination of hardware, software and/or firmware. Thus, for example, any of the example instrumented application 110, the example registrar 114 and/or, more generally, the example media device 102 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example instrumented application 110, the example registrar 114 and/or, more generally, the example media device 102 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example media device 102 of FIG. 1 may include one or more elements, processes and/or devices in addition to, or instead of, those illustrated in FIG. 1, and/or may include more than one of any or all of the illustrated elements, processes and devices.

FIG. 2 is a block diagram of an example implementation of the example monitoring data analyzer 122 of FIG. 2. The example monitoring data analyzer 122 of FIG. 2 enforces consent instructions received from the user(s) of the media device 102 on monitoring data received from the instrumented application 110 and/or other sources of monitoring data. The received monitoring information is indicative of an exposure of a user identified in the monitoring data to media identified in the monitoring data. The example monitoring data analyzer 122 of FIG. 2 analyzes the received monitoring data to determine whether the identified user has consented to monitoring and, thus, whether or not to store personally identifying information (e.g., demographic and/or bibliographic data) associated with the identified user in connection with the identified media. As described above in connection with FIG. 1, the media device 102 obtains (e.g., via the registrar 114 in connection with registration of the user with a panel) consent information provided by one or more users of the media device 102 and conveys the consent information to the example central facility 100. The example monitoring data receiver 122 of FIG. 2 includes a consent tracker 200 to facilitate storage of a consent indicator for each instance of consent information received at the central facility 100. The example consent tracker 200 of FIG. 2 determines whether the received consent information is indicative of permission to monitor or an opt-out selection provided by the user of the media device 102.

To determine an identity of the user providing consent information, the example monitoring data analyzer 122 includes a user extractor 202. The example user extractor 202 of FIG. 2 determines an identity of the user associated with the received consent information and/or an identity of the user associated with the received monitoring data. In some examples, the user extractor 202 analyzes data located in a certain portion of a payload (e.g., of an HTTP request) to identity the user. In some examples, the user extractor 202 analyzes a tag or metadata conveyed with the received consent information and/or monitoring information. Additional or alternative types of information can be used to obtain the identity of the user such as, for example, an Apple® AdId, an Android® device ID, an HTTP cookie, an IP address combined with data from an HTTP User Agent header, etc. In the illustrated example of FIG. 2, the user extractor 202 uses the received information to determine an identifier or label used by the central facility 100 for the corresponding user. For example, the central facility 100 may have stored a user identifier (e.g., a numeric or alphanumeric sequence) corresponding to the user when, for example, the user registers with a monitoring panel associated with the central facility 100. Thus, the example user extractor 202 of FIG. 2 provides the central facility 122 with an identity of the user associated with received information (e.g., consent information and/or monitoring data) according to the record keeping of the central facility 100.

With the identity of the user and the consent information of the received monitoring data, the example consent tracker 200 of FIG. 1 creates an entry in a consent indicator database 204. The example consent indicator database 204 of FIG. 2 stores a consent indicator for the identified user having a value corresponding to the determination made by the consent tracker 200. For example, if the identified user is an opted-in user, the corresponding consent indicator in the consent indicator database 204 is assigned a first value (e.g., a logical one). If the identified user is an opted-out user, the corresponding consent indicator of the consent indicator database 204 is a second value (e.g., a logical zero). Accordingly, the example consent tracker 200 and the example consent indicator database 204 cooperate to maintain records indicative of which users (e.g., of the media device 102 of FIG. 1) have provided an opt-out instruction to the central facility 100. Some or none of the users may be panelists of a media measuring entity. If some are panelists, those users may have provided consent to be monitored as part of the registration process. In such instances, the consent tracker 200 stores a value in the consent indicator database 204 to reflect the provided consent.

The example monitoring data analyzer 122 of FIG. 2 includes an exposure type selector 206 to determine whether an exposure to particular media corresponds to an opted-in user or an opted-out user. The example monitoring data analyzer 122 of FIG. 2 stores a first type of exposure indication or indicator when the user associated with received monitoring data is an opted-in user. The example monitoring data analyzer 122 of FIG. 2 stores a second, different type of exposure indication or indicator when the user associated with the received monitoring data is an opted-out user. The example exposure type selector 206 of FIG. 2 selects the first type of exposure indicator or the second type of exposure indicator for an instance of received monitoring data based on the information stored in the consent indicator database 204 in association with the user identified in the received monitoring data. The example exposure type selector 206 utilizes the user extractor 202 to obtain an identity of the user associated with the received monitoring information. The example exposure type selector 206 of FIG. 2 uses the provided user identifier to query the example consent indicator database 204. The example consent indicator database 204 of FIG. 2 returns a value (e.g., a logical one to indicate that permission has been granted or a logical zero to indicate that an opt-out instruction has been provided by the user) for the consent indicator corresponding to the user of the query.

In the illustrated example, the exposure type selector 206 selects the first type of exposure indicator when the value provided by the consent indicator database 204 is indicative of the corresponding user having provided permission to the media device 102. That is, in the illustrated example, the first type of exposure indicator corresponds to opted-in users that are tracked in an opted-in exposure database 208. In the illustrated example, the exposure type selector 206 selects the second type of exposure indicator when the value provided by the consent indicator database 204 is indicative of the corresponding user having provided an opt-out instruction to the media device 102. That is, in the illustrated example, the second type of exposure indicator corresponds to opted-in users that are tracked in an opted-out exposure database 210. Accordingly, the example exposure type selector 206 of FIG. 2 selects the appropriate type of exposure indication to be stored in the central facility 100 based on privacy instructions provided by the users.

In the illustrated example, the first type of exposure indication corresponding to the opted-in users tracked in the opted-in exposure database 208 is such that personally identifying information, such as demographic information and/or bibliographic information, associated with the user is stored in connection with the media identified in the monitoring information. That is, exposure indications of the first (opted-in) type are those for which personally identifying information is tied to the media identifying information representative of the media to which the user was exposed. In contrast, the second type of exposure indication corresponding to the opted-out users tracked in the opted-out exposure database 210 is such that personally identifying information associated with the user is not stored (e.g., omitted from storage, prevented from being stored, restricted from being stored, destroyed, and/or prohibited from being stored) in connection with the media identified in the monitoring data. That is, exposure indications of the second (opted-out) type are those for which personally identifying information is destroyed and, thus, not tied to the media identifying information representative of the media to which the user was exposed.

To track media exposures of the first (opted-in) type, the example opted-in exposure database 208 includes entries having at least personally identifying information and media identifying information indicative of the corresponding exposure detected by, for example, the instrumented application 110 of FIG. 1. To track media exposures of the second (opted-out) type, the example opted-in exposure database 210 includes entries having media identifying information but not having personally identifying information associated with the user identified in the corresponding monitoring information.

The example monitoring data analyzer 122 of FIG. 2 includes a media extractor 212 to extract and/or obtain media identifying information from the monitoring data received from the media device 102. As described above, the obtained media identifying information is stored in the opted-in exposure database 208 and the opted-out exposure database 210. Depending on whether the corresponding media exposure corresponds to an opted-in or an opted-out user (e.g., according to the exposure type selector 206), the corresponding database entry either (1) includes personally identifying information in addition to the media identifying information or (2) does not include personally identifying information. In the illustrated example of FIG. 2, the personally identifying information (e.g., demographic information and/or bibliographic information) stored in the opted-in exposure database 208 in conjunction with the media identifying information of the monitoring data is obtained from data accompanying the monitoring information, the example data store 120, and/or any other suitable source. That is, the personally identifying information associated with the user may arrive at the central facility 100 in conjunction with the corresponding monitoring data and/or may have been stored at the central facility 100 prior to receiving the monitoring data.

While an example manner of implementing the monitoring data analyzer 122 is illustrated in FIG. 2, one or more of the elements, processes and/or devices illustrated in FIG. 2 may be combined, divided, re-arranged, omitted, eliminated and/or implemented in any other way. Further, the example consent tracker 200, the example user extractor 202, the example exposure type selector 206, the example media extractor 212 and/or, more generally, the example monitoring data analyzer 122 of FIG. 2 may be implemented by hardware, software, firmware and/or any combination of hardware, software and/or firmware. Thus, for example, any of the example consent tracker 200, the example user extractor 202, the example exposure type selector 206, the example media extractor 212 and/or, more generally, the example monitoring data analyzer 122 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example consent tracker 200, the example user extractor 202, the example exposure type selector 206, the example media extractor 212 and/or, more generally, the example monitoring data analyzer 122 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example monitoring data analyzer 122 of FIG. 2 may include one or more elements, processes and/or devices in addition to, or instead of, those illustrated in FIG. 2, and/or may include more than one of any or all of the illustrated elements, processes and devices.

FIG. 3 is a block diagram of an example implementation of the example reporter 124 of FIG. 1. As described above, the example monitoring data analyzer 122 of FIG. 2 populates and maintains the opted-in exposure database 208 and the opted-out exposure database 210 with the appropriate data (according to the corresponding consent information) based on monitoring information is received from, for example, the instrumented application 110 of FIG. 1. The example reporter 124 of FIG. 3 references the information stored in the opted-in exposure database 208 and/or the information stored in the opted-out exposure database 210 to generate one or more reports representative of media exposures. The one or more reports generated by the example reporter 124 of FIG. 3 can be used to measure, for example, popularities of particular media, types of media, categories of media, etc. Different types or categories of media may be, for example, news, movies, television programming, on-demand media, Internet-based media, games, streaming games, advertisements, etc. Because the example central facility 100 receives monitoring data from the media device 102 and other media devices of similar or different type(s), the reports generated by the example reporter 124 of FIG. 3 can additionally or alternatively measure popularities of particular media and/or types of media across different types of devices. Such comparisons may be made across any type(s) and/or numbers of devices including, for example, cell phones, smart phones, dedicated portable multimedia playback devices, iPod® devices, tablet computing devices (e.g., an iPad®), standard-definition (SD) televisions, high-definition (HD) televisions, three-dimensional (3D) televisions, stationary computers, portable computers, Internet radios, etc. Any other type(s) and/or number of media and/or devices may be analyzed. In some examples, the media exposure metrics are used to determine popularity, ratings, engagement indices, user affinities, and/or any other audience measure metric associated with streaming media, locally stored media, broadcast media, websites, non-streaming media, etc. In some examples, the media exposure metrics are audience share metrics indicative of percentages of audiences for different applications and/or types of applications that accessed the same media. For example, a first percentage of an audience may be exposed to news media via a browser application, while a second percentage of the audience may be exposed to the same news media via a news reader application.

The example reporter 124 of FIG. 3 cooperates with the example opted-in exposure database 208 and the example opted-out exposure database 210 of FIG. 2 to generate one or more reports. As described above, the exposure databases 208, 210 include exposure indicators for particular media indicative of a user being exposed to that media. For example, as an illustrative scenario for the example reporter 124, the opted-in exposure database 208 includes a plurality of exposure indications that a particular website was viewed a first number of times by opted-in users. That is, the example opted-in exposure database 208 includes the first number of entries having the website identified as the media to which a user was exposed. Further, the opted-in exposure database 210 includes a plurality of exposure indications that the same website was viewed a second number of times by opted-out users. That is, the example opted-out exposure database 210 includes the second number of entries having the website identified as the media to which a user was exposed. The example reporter 124 of FIG. 3 includes an exposure counter 300 to identify the first and second numbers for the website when, for example, a report regarding the website is scheduled and/or requested. The example exposure counter 300 determines how many entries of the databases 208, 210 correspond to the website. In some examples, the exposure counter 300 queries the databases 208, 210 with a media identifier corresponding to the website and counts the number of returned records from the respective database 208, 210. The example exposure counter 300 may take into consideration a time period (e.g., a week, a day, a month, etc.) corresponding to the scheduled and/or requested report when counting the exposure indicators.

The example reporter 124 of FIG. 3 includes an opted-in profile generator 302 to calculate and/or generate one or more characteristics and/or metrics associated with the entries of the opted-in exposure database 208 corresponding to, for example, the website discussed above. In the illustrated example of FIG. 3, the opted-in profile generator 302 uses the personally identifying information stored in the entries of the opted-in exposure database 208 in conjunction with the website to generate a demographic profile of the user visiting the website. As described above, the entries of the example opted-in exposure database 208 include media identifying information and personally identifying information indicative of, for example, demographic(s) of the person exposed to the identified media. From the first plurality of entries corresponding to the website in the opted-in exposure database 208 counted by the exposure counter 300, the example opted-in profile generator 302 obtains the corresponding demographic information and generates a representation of, for example, a distribution of demographics across the entries. For example, the profile generated by the example opted-in profile generator 302 includes information representative of a distribution of age groups, genders, ethnicities, etc. that have been exposed to the website.

The example reporter 124 of FIG. 3 includes an opted-out profile generator 304 to calculate and/or generate one or more characteristics and/or metrics associated with the entries of the opted-out exposure database 210 corresponding to, for example, the website. As described above, the example opted-out exposure database 210 does not include personally identifying information indicative of, for example, a demographic of the person corresponding to a detected exposure to the website. However, the example reporter 124 of FIG. 3 enables generation of a profile of the opted-out users based on an estimate or extrapolation from the demographics of the opted-in users. In particular, the example opted-out profile generator 304 utilizes an extrapolator 306 to project the demographic profile generated by the opted-in profile generator 302 for the website onto the second plurality of exposure indicators obtained from the opted-out exposure database 210. In the illustrated example of FIG. 3, the extrapolator 306 uses the first number of opted-in users that were exposed to the website, the second number of opted-out users that were exposed to the website, and the demographic profile generated by the opted-in profile generator 302 to determine, for example, an approximate number of opted-out users having a certain demographic characteristic that were exposed to the website. Similar extrapolations are performed for different demographic characteristics such that the example extrapolator 306 has provided estimations and/or approximations of how many opted-out users having different demographic characteristics were exposed to the website. With these estimations and/or approximations, the example opted-out profile generator 304 generates one or more reports indicative of an estimated and/or approximated demographic makeup of the opted-out users that were exposed to the website. While the above example scenario involves a website, additional or alternative types of media, such as an advertisement appearing on a plurality of different websites, can be tracked.

While an example manner of implementing the reporter 124 is illustrated in FIG. 3, one or more of the elements, processes and/or devices illustrated in FIG. 3 may be combined, divided, re-arranged, omitted, eliminated and/or implemented in any other way. Further, the example exposure counter 300, the example opted-in profile generator 302, the example opted-out profile generator 304, the example extrapolator 306 and/or, more generally, the example reporter 124 of FIG. 3 may be implemented by hardware, software, firmware and/or any combination of hardware, software and/or firmware. Thus, for example, any of the example exposure counter 300, the example opted-in profile generator 302, the example opted-out profile generator 304, the example extrapolator 306 and/or, more generally, the example reporter 124 of FIG. 3 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example exposure counter 300, the example opted-in profile generator 302, the example opted-out profile generator 304, the example extrapolator 306 and/or, more generally, the example reporter 124 of FIG. 3 is/are hereby expressly defined to include a tangible computer readable storage device or storage disk such as a memory, a digital versatile disk (DVD), a compact disk (CD), a Blu-ray disk, etc. storing the software and/or firmware. Further still, the example reporter 124 of FIG. 3 may include one or more elements, processes and/or devices in addition to, or instead of, those illustrated in FIG. 3, and/or may include more than one of any or all of the illustrated elements, processes and devices.

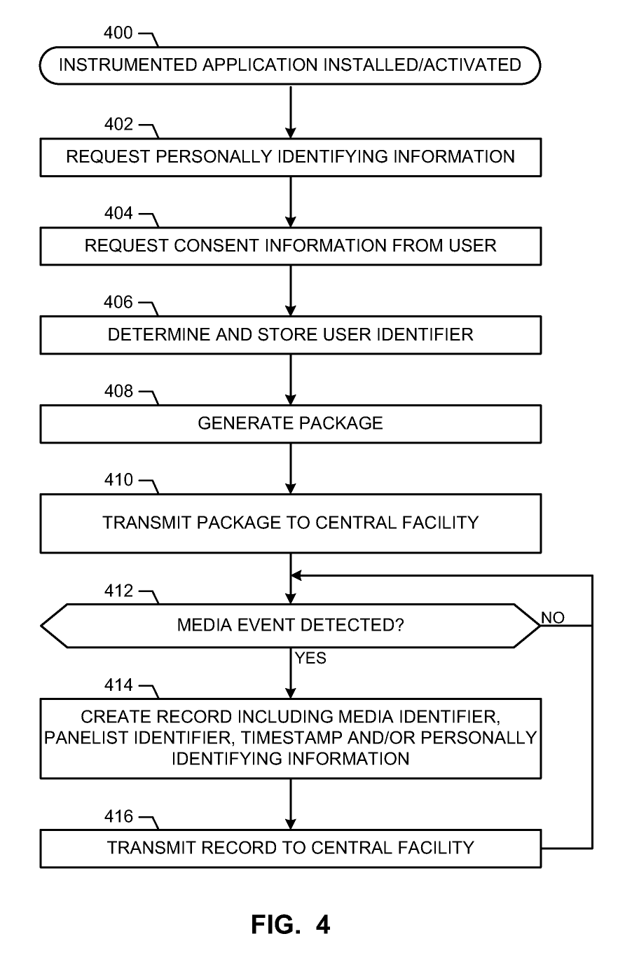

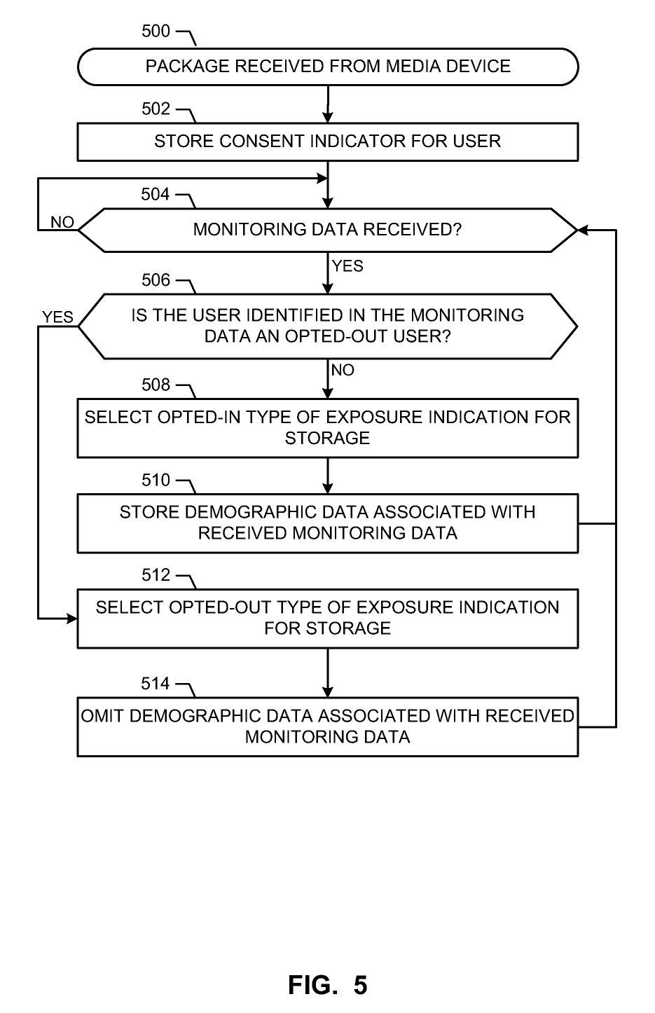

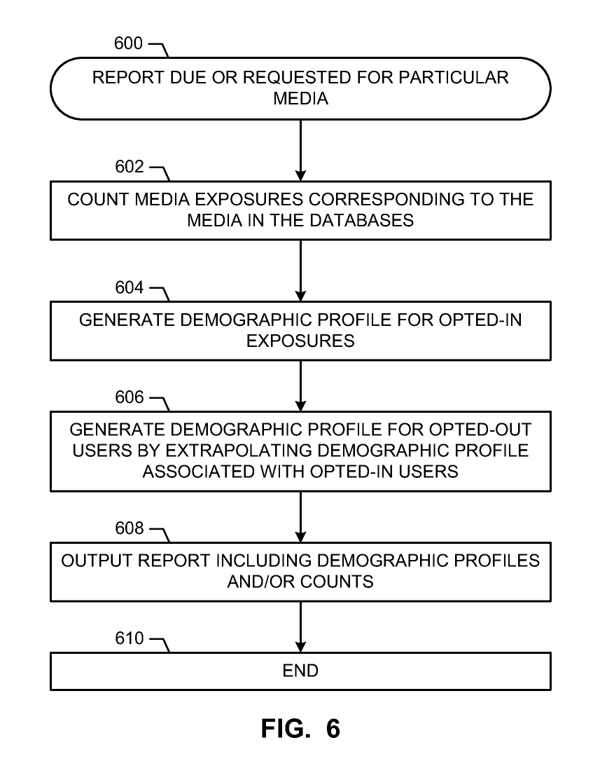

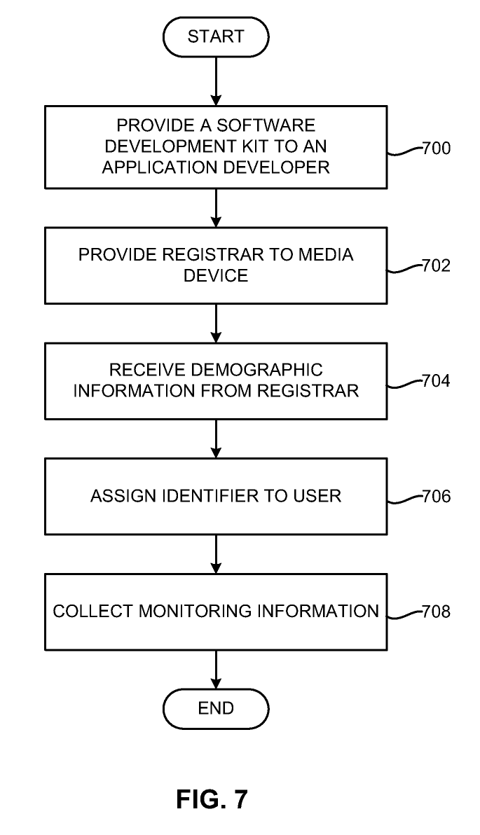

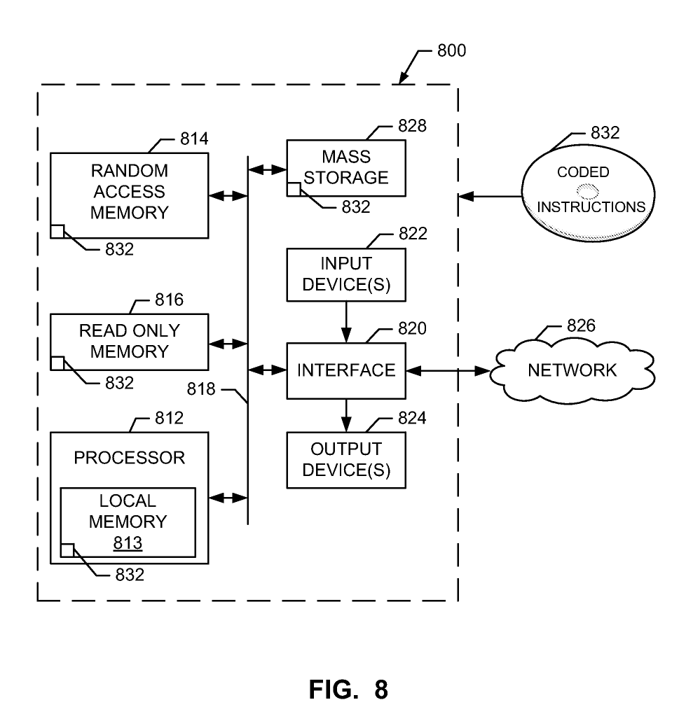

A flowchart representative of example machine readable instructions for implementing the example media device 102 represented in FIG. 1 is shown in FIG. 4. A flowchart representative of example machine readable instructions for implementing the example monitoring data analyzer 122 represented in FIGS. 1 and/or 3 is shown in FIG. 5. A flowchart representative of example machine readable instructions for implementing the example reporter 124 of FIGS. 1 and/or 3 is shown in FIG. 6. A flowchart representative of example machine readable instructions for implementing the example central facility 100 of FIG. 1 is shown in FIG. 7. In these examples, the machine readable instructions comprise programs for execution by a processor such as the processor 812 shown in the example processor platform 800 discussed below in connection with FIG. 8. The programs may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example programs are described with reference to the flowchart illustrated in FIGS. 4-7, many other methods of implementing the example media device 102 of FIG. 1, the example monitoring data analyzer 122 of FIGS. 1 and/or 2, the example reporter 124 of FIG. 3, and/or the example central facility 100 of FIG. 1 may alternatively be used. For example, the order of execution of the blocks may be changed, and/or some of the blocks described may be changed, eliminated, or combined.

As mentioned above, the example processes of FIGS. 4-7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 4-7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 4 begins when the instrumented application 110 of FIG. 1 is activated and/or installed on the media device 102 (block 400). In some examples, the instrumented application 110 and the registrar 114 are installed and/or activated in conjunction and/or at the same time. Additionally or alternatively, the example of FIG. 4 begins when the registrar 114 of FIG. 1 is installed and/or activated on the media device 102. In the example of FIG. 4, the registrar 114 requests personally identifying information from the user of the media device 102 (block 402). For example, the registrar 114 requests, via a survey or series of questions displayed on the media device 102, demographic and/or bibliographic information such as an ethnicity, an income level, an address, interests, and/or on the any other demographic information related to the panelist. The user of the media device 102 provides the requested information in any suitable manner such as, for example, selecting options from drop down menus and/or entering text into fields. In the example of FIG. 4, the registrar 114 requests consent information from the user of the media device 102 (block 404). For example, the registrar 114 presents one or more questions on the media device 102 and one or more corresponding explanations indicative of the consent or opt-out instruction that the user may select. In the illustrated example, the opt-out option includes an explanation that no personally identifying information (e.g., demographic and/or bibliographic information) will be stored in connection with media exposure information detected via the instrumented application 110.

In the example of FIG. 4, the registrar 114 determines an identity of the person by, for example, requesting a name from the user and/or registration number associated with, for example, a monitoring panel to which the user belongs (block 406). Additionally or alternatively, the example registrar 114 obtains a user identifier by, for example, requesting an identifier from the central facility 100. Additional or alternative techniques for generating a user identifier may be employed such as, for example, deriving the identifier based on a social security number, based on a phone number, based on a hardware address of the media device 102 (e.g. a media access control (MAC) address of the media device 102), etc. In the example of FIG. 4, the registrar 114 generates a package of information including at least the user identifier, the consent information and any personally identifying information (e.g., demographic information) received from the user (block 408). The media device 102 sends the package to the central facility 100 (block 410). As such, the central facility 100 is made aware of the identity of the user, personally identifying information associated with the identified user, and whether or not the user has provided an opt-out instruction related to monitoring functionality of the instrumented application 110. In some examples, the central facility 100 determines whether the received information corresponds to a panelist opting out of the monitoring functionality. For example, the central facility 100 compares the received identity of the user to a list of panelist identifiers. If the received information indicates that a panelist has opted out, the example central facility 100 sends a message to the user regarding the conflict between opting out and the membership agreement. In the illustrated example, the user is able to opt out similar to a non-panelist, but is removed from the panel.

The example instrumented application 110 detects media events occurring on the media device 102 and/or in an environment in which the media device 102 is located. Example media events include media being presented on the media device 102, media being presented in the environment in which the media device 102 is located, the user making a media-related selection from on the media device 102 (e.g., an instruction to download and/or stream media to the media device 102), termination of a media session on the media device, etc. When a media event is detected (block 412), the example instrumented application 110 gathers information related to the detected media event, creates a record including the gathered information, and sends the record to the central facility 100 (block 414). The record generated by the instrumented application 110 includes, for example, media identifier(s), user identifier(s), timestamp information, and/or personally identifying information (e.g., demographic information). The media identifiers are generated and/or obtained by the instrumented application 110 by, for example, extracting media-identifying metadata from an ID3 tag transmitted in association with the presented media (see, for example, U.S. patent application Ser. No. 13/341,646, U.S. patent application Ser. No. 13/341,661, U.S. patent application Ser. No. 13/443,596, U.S. patent application Ser. No. 13/455,961, U.S. patent application Ser. No. 13/341,646, and U.S. patent application Ser. No. 13/472,170). In some examples, the instrumented application 110 determines the media identifier by extracting, decoding, etc. a code, a signature, and/or a watermark embedded in the presented media. The media device 102 sends the record to the central facility 100 (block 416). In the illustrated example, the record is formatted as a comma separated value (CSV) record. However, any other type(s) and/or format(s) of record may additionally or alternatively be used. For example, the record may be formatted as an extensible markup language (XML) record. The example instrumented application 110 continues to monitor the media device 102 and/or the environment in which the media device 102 is located, as control returns to block 412.

FIG. 5 begins with receipt at the central facility 100 of the package sent by the media device described above in connection with block 410 of FIG. 4 (block 500). As described above, the received package includes consent information provided by the user. In the example of FIG. 5, the consent information corresponding to the received package is stored at the central facility 100 in the consent indicator database 204 (block 502). In the illustrated example of FIG. 5, storing the consent indicator includes the consent tracker 200 identifying the consent information of the received package as indicative of an opted-in user or an opted-out user and the user extractor 202 determining an identity of the corresponding user (block 502). That is, the consent tracker 200 and the user extractor 202 cooperate to store a consent indicator in the consent indicator database 204 having a first value indicative of an opted-in user or a second value indicative of an opted-out user. The appropriate value is stored in the corresponding consent indicator of the consent indicator database 204 (block 502).

As described above, the example central facility 100 receives monitoring data from, for example, the instrumented application 110 corresponding to detected media exposures. In the example of FIG. 5, when the monitoring data analyzer 122 receives such monitoring data (block 504), the example exposure type selector 206 uses user identifying information associated with the received monitoring data to query the consent indicator database 204 (block 506). The reply from the example consent indicator database 204 indicates the user that was exposed to the media identified in the received monitoring data is an opted-in user or an opted-out user (block 506). In the illustrated example, the exposure type selector 206 selects the first (opted-in) type of exposure indicator when the value provided by the consent indicator database 204 is indicative of the corresponding user having opted-in to the monitoring (block 508). In the example of FIG. 5, selection of the first (opted-in) type of exposure indicator for storage causes demographic information associated with the identified user to be stored in connection with the media identifying information (e.g., as extracted from the monitoring data by the media extractor 212) of the received monitoring data in the opted-in exposure database 208 (block 510). Additional or alternative types of personally identifying information (e.g., bibliographic information) may be stored in connection with the media identifying information for opted-in users.

On the other hand, the exposure type selector 206 selects the second (opted-out) type of exposure indicator when the value provided by the consent indicator database 204 at block 506 is indicative of the corresponding user being an opted-out user (block 512). In the example of FIG. 5, selection of the second (opted-out) type of exposure indicator for storage causes personally identifying information associated with the identified user to be omitted from records corresponding to the media exposure in the opted-out exposure database 210 (block 514). Control returns to block 504. Accordingly, the example of FIG. 5 populates the exposure databases 208, 210 in accordance with consent information provided by the user of the media device 102.

FIG. 6 begins with a report regarding particular media being due and/or requested (block 600). The example reporter 124 calculates a first count of exposure indicators corresponding to the particular media in the opted-in exposure database 208 and a second count of exposure indicators corresponding to the particular media in the opted-out database 210 (block 602). In the example of FIG. 6, the first and second counts are for a time period (e.g., a week, a day, a month, etc.) corresponding to the scheduled and/or requested report. In the example of FIG. 6, the example opted-in profile generator 302 generates a demographic profile including one or more characteristics and/or metrics associated with the entries of the opted-in exposure database 208 counted by the exposure counter 300 (block 604). While the example of FIG. 6 includes generating a demographic profile, additional or alternative personally identifying information (e.g., bibliographic information) may be factored into and/or relied on for the generated profile. The example opted-out profile generator 304 uses the demographic profile generated for the opted-in users to generate an estimated and/or approximated demographic profile for the opted-out users corresponding to the second count generated by the exposure counter 300 (block 606). In particular, the example opted-out profile generator 304 utilizes the extrapolator 306 to project the demographic profile associated with the opted-in users onto the opted-out users (block 606). The example reporter 608 outputs the demographic profile(s) generated by the profile generator(s) 302, 304, and/or the counts generated by the example exposure counter 300 to a requestor and/or a scheduled recipient (block 608). The example of FIG. 6 then ends (block 610).

FIG. 7 is a flowchart representative of example machine-readable instructions that may be executed to implement the central facility 100 of FIG. 1. The example of FIG. 5 begins when the SDK provider 118 of the central facility 100 providing an SDK to an application developer such as, for example, the media provider 106 and/or a developer associated with the app store 108 (block 700). The SDK provided by the example SDK provider 118 enables the receiving application developer to create, for example, the instrumented application 110. In the illustrated example, monitoring functionality is provided via the provided SDK. However, monitoring functionality may be provided via, for example, an API, a programming library, a dynamically linked library (DLL), a plug-in, an add-on, etc.

In the illustrated example, the example central facility 100 provides (e.g., HTTP interface 116) the registrar 114 to the media device 102 (block 702). In some examples, the registrar 114 is provided via the app store 108 such as, for example, Apple iTunes, Google Play, etc. In some examples, the registrar 114 is provided directly to the media device 102 via, for example, a website, a mailed compact disc, etc. In some examples, the registrar 14 is provided to a media device manufacturer and/or reseller. In examples where the registrar 1114 is provided to the media device manufacturer, the media device manufacturer may design (e.g., develop, produce, manufacture, etc.) the media device 102 with the registrar 114 as an integrated component. In examples where the registrar 114 is provided to the reseller, the reseller may install (e.g., modify, alter, adapt, etc.) the media device 102 to include the registrar 114 at or prior to the time of sale of the media device 102 to the retailer and/or to the end user (e.g., the consumer).

The example registrar 114 provides demographic information to the central facility 100 (block 704). In some examples, the demographic information is collected for opted-in user but not opted-out users. In the illustrated example, the central facility 100 assigns an identifier to the newly registered user (block 706). In some examples, the identifier is generated based on the demographic information. The identifier is then stored in a memory (e.g., a pasteboard) on the media device 102 and/or the central facility 100. In the illustrated example, the central facility 100 begins collecting monitoring data (e.g., media identifying information (e.g., media-identifying metadata, codes, signatures, watermarks, and/or other information that may be used to identify presented media), an identifier, a time and/or duration of use, a rating, etc.), and/or user-identifying information (e.g., demographic information, a user identifier, a username, etc.). The example of FIG. 7 then ends.

FIG. 8 is a block diagram of an example processor platform 800 capable of executing the instructions of FIG. 4 to implement the example media device 102 of FIG. 1, the instructions of FIG. 5 to implement the example monitoring data analyzer 122 of FIGS. 1 and/or 2, and/or the instructions of FIG. 6 to implement the example reporter 124 of FIG. 1 and/or 3. The processor platform 800 can be, for example, a server, a personal computer, a mobile device (e.g., a cell phone, a smart phone, a tablet such as an iPad™), a personal digital assistant (PDA), an Internet appliance, a smart TV, a DVD player, a CD player, a digital video recorder, a Blu-ray player, a gaming console, a personal video recorder, a set top box, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIGS. 4, 5, 6 and/or 7 may be stored in the mass storage device 828, in the volatile memory 814, in the non-volatile memory 816, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
storing a consent indicator at a central facility in connection with a user identifier corresponding to a user of a media device; and
when monitoring data representative of an exposure the user to first media is received at the central facility:
determining, at the central facility, a value of the consent indicator;
when the value indicates that the user is an opted-in user, storing, at the central facility, personally identifying information associated with the user in connection with an identification of the first media; and
when the value indicates that the user is an opted-out user, storing, at the central facility, the identification of the first media without storing the personal identifying information associated with the user in connection with the identification of the first media.

2. A method as defined in claim 1, wherein the personally identifying information associated with the user is known to the central facility prior to the monitoring data being received at the central facility.

3. A method as defined in claim 1, wherein the personally identifying information associated with the user is received at the central facility with the monitoring data.

4. A method as defined in claim 1, wherein when the value indicates the user is the opted-in user, selecting a first database to store the monitoring data, the first database including the personally identifying information.

5. A method as defined in claim 4, wherein when the value indicates the user is the opted-out user, selecting a second database different from the first database to store the monitoring data, the second database being prohibited from storing the personally identifying information.

6. A method as defined in claim 1, further comprising generating, based on the personally identifying information stored in connection with the identification of the first media, a first demographic profile of a first plurality of opted-in users.

7. A method as defined in claim 6, further comprising generating, based on the first demographic profile, a second demographic profile of a second plurality of opted out users.

8. A method as defined in claim 7, wherein generating the second demographic profile based on the first demographic profile comprises projecting characteristics of the first demographic profile.

9. A tangible computer readable storage medium having instructions stored thereon that, when executed, cause a central facility to at least:
store a consent indicator in connection with a user of a media device; and
when monitoring data representative of an exposure of the user to first media is received:
determine a value of the consent indicator;
when the value indicates that the user is an opted-in user, store personally identifying information associated with the user and an identification of the first media; and
when the value indicates that the user is an opted-out user, store the identification of the first media without storing the personally identifying information associated with the user in connection with the identification of the first media.

10. A storage medium as defined in claim 9, wherein the personally identifying information associated with the user is known to the central facility prior to the monitoring data being received at the central facility.

11. A storage medium as defined in claim 9, wherein the personally identifying information associated with the user is received at the central facility with the monitoring data.

12. A storage medium as defined in claim 9, wherein the instructions cause the central facility to, when the value indicates the user is the opted in user, select a first database to store the monitoring data, the first database including the personally identifying information.

13. A storage medium as defined in claim 12, wherein the instructions cause the central facility to, when the value indicates the user is the opted out user, select a second database different from the first database to store the monitoring data, the second database being prohibited from storing the personally identifying information in connection with the media identifying information.

14. A storage medium as defined in claim 9, wherein the instructions cause the central facility to generate, based on the personally identifying information stored in connection with the first media, a first demographic profile of a first plurality of opted in users.

15. A storage medium as defined in claim 14, wherein the instructions cause the central facility to generate, based on the first demographic profile, a second demographic profile of a second plurality of opted out users.

16. A storage medium as defined in claim 15, wherein generating the second demographic profile based on the first demographic profile comprises projecting characteristics of the first demographic profile.

17. A central facility, comprising:
a first database to store first media exposure indicators, the first media exposure indicators including demographic information associated with opted-in users and media identifying information indicative of media to which the opted-in users were exposed;
a second database to store second media exposure indicators, the second media exposure indicators excluding demographic information associated with opted-out users and including media identifying information indicative of media to which the opted-out users were exposed; and
a selector to select the first database or the second database for storage of received monitoring data based on consent information stored at the central facility associated with a user identified in the monitoring data.

18. A central facility as defined in claim 17, the central facility being aware of the demographic information associated with the opted-out users, and not storing the demographic information associated with the opted-out users is connection with media identifying information.

19. A central facility as defined in claim 17, further comprising a consent tracker to obtain the consent information from users of media devices having monitoring functionality installed.

20. A central facility as defined in claim 17, further comprising:
a first demographic profile generator to generate a first demographic profile based on data in the first database; and
a second demographic profile generator to generate a second demographic profile based on the first demographic profile and data in the second database.
